(19) United States
(12) Patent Application Publication
(10) Pub. No.: US 2018/0077482 A1
(43) Pub. Date: Mar. 15, 2018

(54) Noise Reduction Headset Setting Method, Terminal, and Noise Reduction Headset

(71) Applicant: Huawei Technologies Co., Ltd., Shenzhen, Guangdong (CN)

(72) Inventors: Yao Yuan, Shanghai (CN); Zhonghui Peng, Shanghai (CN)

(21) Appl. No.: 15/563,438

(22) PCT Filed: May 15, 2015
(86) PCT No.: PCT/CN2015/079030

§ 371 Date: Sep. 29, 2017

(51) Int. Cl. H04R 1/10; H04R 1/08; G10K 11/175; G06F 9/445

(52) U.S. Cl. CPC H04R 1/1083; H04R 1/1041; G06F 8/65; G10K 11/175; H04R 1/08

(57) ABSTRACT

A noise reduction headset setting method includes triggering a noise reduction headset to enter a communication mode when it is detected that the noise reduction headset is inserted into a preset headset jack and a communication setting instruction is received, where the preset headset jack includes a first line used by a first channel and a sending channel, a second line used by a second channel and a receiving channel, and a third line used by a microphone and communication triggering, receiving a headset setting request in the communication mode, where the headset setting request requests a firmware upgrade or noise reduction parameter setting for the noise reduction headset, and setting the noise reduction headset according to the headset setting request using the preset headset jack.

### CROSS-REFERENCE TO RELATED APPLICATION

This application is a U.S. National Stage of International Patent Application No. PCT/CN2015/079030 filed on May 15, 2015, which is hereby incorporated by reference in its entirety.

### TECHNICAL FIELD

Embodiments of the present disclosure relate to audio processing technologies, and in particular, to a noise reduction headset setting method, a terminal, and a noise reduction headset.

### BACKGROUND

For a noise reduction headset, a dedicated noise reduction circuit is provided in the headset, and generally an audio receiver (for example, a mini microphone) and an anti-noise output chip are used to receive and analyze a frequency of ambient noise and generate a reverse frequency of the frequency of the ambient noise for mutual attenuation or cancellation, thereby suppressing noise.

However, when a noise reduction headset leaves the factory, internal firmware, an audio parameter for noise reduction, and the like of the noise reduction headset are all fixed and unchangeable, and a noise reduction range cannot be flexibly adjusted, reducing practicability of the noise reduction headset.

### SUMMARY

Embodiments of the present disclosure provide a noise reduction headset setting method, a terminal, and a noise reduction headset to flexibly adjust a noise reduction range of a noise reduction headset, and improve practicability of the noise reduction headset.

According to a first aspect, an embodiment of the present disclosure provides a noise reduction headset setting method, including triggering the noise reduction headset to enter a communication mode when it is detected that a noise reduction headset is inserted into a preset headset jack and a communication setting instruction is received, where the preset headset jack includes a first line used by a first channel and a sending channel, a second line used by a second channel and a receiving channel, and a third line used by a microphone and communication triggering, the first channel and the second channel are respectively one of a left channel and a right channel, and the first channel and the second channel are different, and in the communication mode, the first line is used for the sending channel, the second line is used for the receiving channel, and the third line is used for the communication triggering, receiving a headset setting request in the communication mode, where the headset setting request is used to request a firmware upgrade and/or noise reduction parameter setting for the noise reduction headset, and setting the noise reduction headset according to the headset setting request using the preset headset jack.

With reference to the first aspect, in a first possible implementation manner of the first aspect, triggering the noise reduction headset to enter a communication mode when it is detected that a noise reduction headset is inserted into a preset headset jack and a communication setting instruction is received includes outputting, according to the communication setting instruction using the third line, a level signal conforming to a preset trigger state, and triggering, after the level signal is output for a preset trigger time, the noise reduction headset to enter the communication mode when it is detected that the noise reduction headset is inserted into the preset headset jack and the communication setting instruction is received.

With reference to the first aspect or the first possible implementation manner of the first aspect, in a second possible implementation manner of the first aspect, the headset setting request includes a firmware upgrade request, and setting the noise reduction headset according to the headset setting request using the preset headset jack includes obtaining a model of the noise reduction headset and a current firmware version of the noise reduction headset according to the firmware upgrade request, and downloading the firmware for update, and sending the firmware for update to the noise reduction headset using the sending channel if it is found, through searching according to the model of the noise reduction headset and the current firmware version of the noise reduction headset, that there is firmware for update corresponding to the model of the noise reduction headset.

With reference to any one of the first aspect, or the first to the second possible implementation manners of the first aspect, in a third possible implementation manner of the first aspect, the headset setting request includes noise reduction parameter information, and setting the noise reduction headset according to the headset setting request using the preset headset jack includes sending a noise reduction level in the noise reduction parameter information to the noise reduction headset using the sending channel such that the noise reduction headset filters noise according to the noise reduction level.

With reference to any one of the first aspect, or the first to the second possible implementation manners of the first aspect, in a fourth possible implementation manner of the first aspect, the headset setting request includes an application scenario, and setting the noise reduction headset according to the headset setting request using the preset headset jack includes sending a preset noise reduction level corresponding to the application scenario to the noise reduction headset using the sending channel such that the noise reduction headset filters noise according to the preset noise reduction level.

With reference to any one of the first aspect, or the first to the second possible implementation manners of the first aspect, in a fifth possible implementation manner of the first aspect, the headset setting request includes noise reduction parameter information, and setting the noise reduction headset according to the headset setting request using the preset headset jack includes sending an audio intensity curve in the noise reduction parameter information to the noise reduction headset using the sending channel such that the noise reduction headset adjusts audio intensity of a corresponding sound frequency band according to the audio intensity curve.

With reference to any one of the first aspect, or the first to the fifth possible implementation manners of the first aspect, in a sixth possible implementation manner of the first aspect, after setting the noise reduction headset according to the headset setting request using the preset headset jack, the method further includes receiving a setting exiting request, and outputting, according to the setting exiting request using the third line, a level signal conforming to a preset exiting state to trigger the noise reduction headset to enter a voice mode, where in the voice mode, the first line is used for the first channel, the second line is used for the second channel, and the third line is used for the microphone.

With reference to any one of the first aspect, or the first to the sixth possible implementation manners of the first aspect, in a seventh possible implementation manner of the first aspect, before triggering the noise reduction headset to enter a communication mode when it is detected that a noise reduction headset is inserted into a preset headset jack and a communication setting instruction is received, the method further includes displaying an interface for setting the noise reduction headset to a user, and receiving, using the interface, the headset setting request input by the user.

With reference to the first aspect, in an eighth possible implementation manner of the first aspect, after triggering the noise reduction headset to enter a communication mode when it is detected that a noise reduction headset is inserted into a preset headset jack and a communication setting instruction is received, the method further includes obtaining a model of the noise reduction headset and a current firmware version of the noise reduction headset, and downloading the firmware for update, and sending the firmware for update to the noise reduction headset using the sending channel if it is found, through searching according to the model of the noise reduction headset and the current firmware version of the noise reduction headset, that there is firmware for update corresponding to the model of the noise reduction headset.

According to a second aspect, an embodiment of the present disclosure provides a noise reduction headset setting method, including entering a communication mode according to a start triggering instruction of a terminal after a headset plug is inserted into a preset headset jack of the terminal, where the headset plug includes a first line used by a first channel and a receiving channel, a second line used by a second channel and a sending channel, and a third line used by a microphone and communication triggering, the first channel and the second channel are respectively one of a left channel and a right channel, and the first channel and the second channel are different, and in the communication mode, the first line is used for the receiving channel, the second line is used for the sending channel, and the third line is used for the communication triggering, receiving, in the communication mode using the headset plug, setting information sent by the terminal, and setting according to the setting information.

With reference to the second aspect, in a first possible implementation manner of the second aspect, receiving, in the communication mode using the headset plug, setting information sent by the terminal, and setting according to the setting information includes sending, in the communication mode, a model of the noise reduction headset and a current firmware version of the noise reduction headset to the terminal using the sending channel, receiving, using the receiving channel, firmware for update sent by the terminal, and performing an upgrade according to the firmware for update.

With reference to the second aspect or the first possible implementation manner of the second aspect, in a second possible implementation manner of the second aspect, receiving, in the communication mode using the headset plug, setting information sent by the terminal, and setting according to the setting information includes receiving, in the communication mode using the receiving channel, a noise reduction level sent by the terminal, and filtering noise according to the noise reduction level.

With reference to the second aspect or the first possible implementation manner of the second aspect, in a third possible implementation manner of the second aspect, receiving, in the communication mode using the headset plug, setting information sent by the terminal, and setting according to the setting information includes receiving, in the communication mode using the receiving channel, an audio intensity curve sent by the terminal, and adjusting audio intensity of a corresponding sound frequency band according to the audio intensity curve.

With reference to any one of the second aspect, or the first to the third possible implementation manners of the second aspect, in a fourth possible implementation manner of the second aspect, after receiving, in the communication mode using the headset plug, setting information sent by the terminal, and setting according to the setting information, the method further includes entering a voice mode according to an exit triggering instruction of the terminal, where in the voice mode, the first line is used for the first channel, the second line is used for the second channel, and the third line is used for the microphone.

According to a third aspect, an embodiment of the present disclosure provides a terminal, including a trigger module configured to trigger the noise reduction headset to enter a communication mode when it is detected that a noise reduction headset is inserted into a preset headset jack and a communication setting instruction is received, where the preset headset jack includes a first line used by a first channel and a sending channel, a second line used by a second channel and a receiving channel, and a third line used by a microphone and communication triggering, the first channel and the second channel are respectively one of a left channel and a right channel, and the first channel and the second channel are different, and in the communication mode, the first line is used for the sending channel, the second line is used for the receiving channel, and the third line is used for the communication triggering, a receiving module configured to receive a headset setting request in the communication mode, where the headset setting request is used to request a firmware upgrade and/or noise reduction parameter setting for the noise reduction headset, and a setting module configured to set the noise reduction headset according to the headset setting request using the preset headset jack.

With reference to the third aspect, in a first possible implementation manner of the third aspect, when it is detected that the noise reduction headset is inserted into the preset headset jack and the communication setting instruction is received, the trigger module is further configured to output, according to the communication setting instruction using the third line, a level signal conforming to a preset trigger state, and trigger the noise reduction headset to enter the communication mode after the level signal is output for a preset trigger time.

With reference to the third aspect or the first possible implementation manner of the third aspect, in a second possible implementation manner of the third aspect, the headset setting request includes a firmware upgrade request, and the setting module is further configured to obtain a model of the noise reduction headset and a current firmware version of the noise reduction headset according to the firmware upgrade request, and download the firmware for update, and send the firmware for update to the noise reduction headset using the sending channel if it is found, through searching according to the model of the noise reduction headset and the current firmware version of the noise reduction headset, that there is firmware for update corresponding to the model of the noise reduction headset.

With reference to any one of the third aspect, or the first to the second possible implementation manners of the third aspect, in a third possible implementation manner of the third aspect, the headset setting request includes noise reduction parameter information, and the setting module is further configured to send a noise reduction level in the noise reduction parameter information to the noise reduction headset using the sending channel such that the noise reduction headset filters noise according to the noise reduction level.

With reference to any one of the third aspect, or the first to the second possible implementation manners of the third aspect, in a fourth possible implementation manner of the third aspect, the headset setting request includes an application scenario, and the setting module is further configured to send a preset noise reduction level corresponding to the application scenario to the noise reduction headset using the sending channel such that the noise reduction headset filters noise according to the preset noise reduction level.

With reference to any one of the third aspect, or the first to the second possible implementation manners of the third aspect, in a fifth possible implementation manner of the third aspect, the headset setting request includes noise reduction parameter information, and the setting module is further configured to send an audio intensity curve in the noise reduction parameter information to the noise reduction headset using the sending channel such that the noise reduction headset adjusts audio intensity of a corresponding sound frequency band according to the audio intensity curve.

With reference to any one of the third aspect, or the first to the fifth possible implementation manners of the third aspect, in a sixth possible implementation manner of the third aspect, the trigger module is further configured to receive a setting exiting request, and output, according to the setting exiting request using the third line, a level signal conforming to a preset exiting state, to trigger the noise reduction headset to enter a voice mode, where in the voice mode, the first line is used for the first channel, the second line is used for the second channel, and the third line is used for the microphone.

With reference to any one of the third aspect, or the first to the sixth possible implementation manners of the third aspect, in a seventh possible implementation manner of the third aspect, the terminal further includes a display module configured to display an interface for setting the noise reduction headset to a user, and receive, using the interface, the headset setting request input by the user.

With reference to the third aspect, in an eighth possible implementation manner of the third aspect, the setting module is further configured to obtain a model of the noise reduction headset and a current firmware version of the noise reduction headset, and if it is found, through searching according to the model of the noise reduction headset and the current firmware version of the noise reduction headset, that there is firmware for update corresponding to the model of the noise reduction headset, download the firmware for update, and send the firmware for update to the noise reduction headset using the sending channel.

According to a fourth aspect, an embodiment of the present disclosure provides a noise reduction headset, including a receiving module configured to enable, according to a start triggering instruction of the terminal, the noise reduction headset to enter a communication mode after a headset plug is inserted into a preset headset jack of a terminal, where the headset plug includes a first line used by a first channel and a receiving channel, a second line used by a second channel and a sending channel, and a third line used by a microphone and communication triggering, the first channel and the second channel are respectively one of a left channel and a right channel, and the first channel and the second channel are different, and in the communication mode, the first line is used for the receiving channel, the second line is used for the sending channel, and the third line is used for the communication triggering, and a setting module configured to receive, in the communication mode using the headset plug, setting information sent by the terminal, and set according to the setting information.

With reference to the fourth aspect, in a first possible implementation manner of the fourth aspect, the setting module is further configured to send, in the communication mode, a model of the noise reduction headset and a current firmware version of the noise reduction headset to the terminal using the sending channel, and receive, using the receiving channel, firmware for update sent by the terminal, and perform an upgrade according to the firmware for update.

With reference to the fourth aspect or the first possible implementation manner of the fourth aspect, in a second possible implementation manner of the fourth aspect, the setting module is further configured to receive, in the communication mode using the receiving channel, a noise reduction level sent by the terminal, and filter noise according to the noise reduction level.

With reference to the fourth aspect or the first possible implementation manner of the fourth aspect, in a third possible implementation manner of the fourth aspect, the setting module is further configured to receive, in the communication mode using the receiving channel, an audio intensity curve sent by the terminal, and adjust audio intensity of a corresponding sound frequency band according to the audio intensity curve.

With reference to any one of the fourth aspect, or the first to the third possible implementation manners of the fourth aspect, in a fourth possible implementation manner of the fourth aspect, the receiving module is further configured to enable, according to an exit triggering instruction of the terminal, the noise reduction headset to enter a voice mode, where in the voice mode, the first line is used for the first channel, the second line is used for the second channel, and the third line is used for the microphone.

According to a fifth aspect, an embodiment of the present disclosure provides a terminal, including a processor, a preset headset jack, a display, and a memory, where the display includes a touch-sensitive surface and a display screen. The memory is configured to store one or more application programs. The preset headset jack includes a first line used by a first channel and a sending channel, a second line used by a second channel and a receiving channel, and a third line used by a microphone and communication triggering, the first channel and the second channel are respectively one of a left channel and a right channel, and the first channel and the second channel are different, and when the preset headset jack is in a communication mode, the first line is used for the sending channel, the second line is used for the receiving channel, and the third line is used for the communication triggering, and the processor is configured to execute the method in any of the first aspect, or the first to the eighth possible implementation manners of the first aspect.

With reference to the fifth aspect, in a first possible implementation manner of the fifth aspect, the preset headset jack further includes a power line and a ground line.

With reference to the fifth aspect or the first possible implementation manner of the fifth aspect, in a second possible implementation manner of the fifth aspect, the one or more application programs include an application program for setting a noise reduction headset, and the display is configured to display an interface of the application program for setting a noise reduction headset to a user.

According to a sixth aspect, an embodiment of the present disclosure provides a noise reduction headset, including a headset plug and a noise reduction chip, where the headset plug includes a first line used by a first channel and a receiving channel, a second line used by a second channel and a sending channel, and a third line used by a microphone and communication triggering, the first channel and the second channel are respectively one of a left channel and a right channel, and the first channel and the second channel are different, and when the noise reduction headset is in a communication mode, the first line is used for the receiving channel, the second line is used for the sending channel, and the third line is used for the communication triggering, and the noise reduction chip is configured to execute the method in any of the second aspect, or the first to the fourth possible implementation manners of the second aspect.

According to a seventh aspect, an embodiment of the present disclosure provides a computer readable storage medium storing one or more application programs, where the one or more application programs include an instruction, and when executed by a terminal including a display and multiple application programs, the instruction causes the terminal to execute the method in any of the first aspect, or the first to the eighth possible implementation manners of the first aspect, and the display includes a touch-sensitive surface and a display screen.

By means of the noise reduction headset setting method, the terminal, and the noise reduction headset in the embodiments of the present disclosure, by extending lines of a headset jack of a terminal and a plug of a noise reduction headset, data communication between the terminal and the noise reduction headset is implemented, a problem that internal firmware, an audio parameter for noise reduction, and the like of a noise reduction headset are all fixed and unchangeable when the noise reduction headset leaves the factory is resolved, a noise reduction range of the noise reduction headset is flexibly adjusted, and practicability of the noise reduction headset is improved.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show some embodiments of the present disclosure, and a person of ordinary skill in the art may still derive other drawings from these accompanying drawings without creative efforts.

FIG. 1 is a flowchart of an embodiment of a noise reduction headset setting method according to the present disclosure;

FIG. 2 is a flowchart of another embodiment of a noise reduction headset setting method according to the present disclosure;

FIG. 3 is a schematic structural diagram of an embodiment of a terminal according to the present disclosure;

FIG. 4 is a schematic structural diagram of another embodiment of a terminal according to the present disclosure;

FIG. 5 is a schematic structural diagram of an embodiment of a noise reduction headset according to the present disclosure;

FIG. 6 is a schematic diagram of connection between a terminal and a noise reduction headset according to the present disclosure; and

FIG. 7A, FIG. 7B, and FIG. 7C are schematic diagrams of interfaces of a mobile phone according to the present disclosure.

### DESCRIPTION OF EMBODIMENTS

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. The described embodiments are some but not all of the embodiments of the present disclosure. All other embodiments obtained by a person of ordinary skill in the art based on the embodiments of the present disclosure without creative efforts shall fall within the protection scope of the present disclosure.

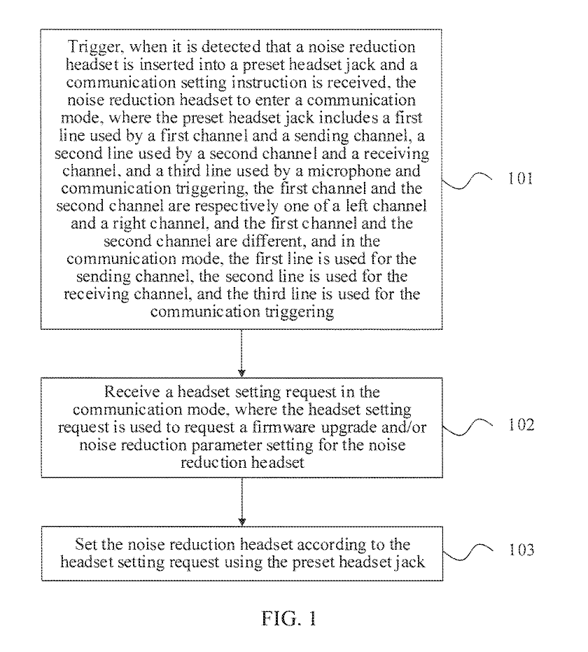

FIG. 1 is a flowchart of an embodiment of a noise reduction headset setting method according to the present disclosure. As shown in FIG. 1, the method in this embodiment may include the following steps.

Step 101: Trigger, when it is detected that a noise reduction headset is inserted into a preset headset jack and a communication setting instruction is received, the noise reduction headset to enter a communication mode, where the preset headset jack includes a first line used by a first channel and a sending channel, a second line used by a second channel and a receiving channel, and a third line used by a microphone and communication triggering, the first channel and the second channel are respectively one of a left channel and a right channel, and the first channel and the second channel are different, and in the communication mode, the first line is used for the sending channel, the second line is used for the receiving channel, and the third line is used for the communication triggering.

This embodiment may be executed by a terminal, and the terminal may be, for example, a mobile phone or a tablet computer. The terminal may be used as the terminal in this embodiment provided that the terminal has a function of outputting audio using a headset jack. A headset with a microphone generally has four sections, including a left channel, a right channel, a ground line, and a microphone. Correspondingly, a headset jack of a terminal also includes the foregoing four lines matching the headset. To implement the method in this embodiment, the original lines of the headset jack of the terminal may be extended. A first line may be used to transmit left channel audio and send data, a second line may be used to transmit right channel audio and receive data, and a third line may be used to control the microphone and trigger communication. Correspondingly, to match the line extension of the headset jack, lines of a plug of a noise reduction headset also need to be extended, including a first line used to transmit left channel audio and receive data, a second line used to transmit right channel audio and send data, and a third line used to control the microphone and trigger communication. In addition, in this embodiment, the first line in the headset jack of the terminal may also be a line used by right channel audio and a sending channel, and the second line may also be a line used by left channel audio and a receiving channel. That is, which lines and how the lines are used for left and right channels and a data channel are not limited for the headset jack and the plug of the noise reduction headset, and the headset jack and the plug of the noise reduction headset may be applicable in the present disclosure provided that the headset jack and the plug of the noise reduction headset are provided with a data transmission function, and data transmission channels are corresponding. In this way, in addition to outputting audio using the headset jack, the terminal may also perform data communication with the noise reduction headset using the headset jack to set a noise reduction range of the noise reduction headset, and may perform a firmware upgrade on the noise reduction headset. For the noise reduction headset, a dedicated noise reduction circuit is provided in the headset, and generally an audio receiver (for example, a mini microphone) and an anti-noise output chip are used to receive and analyze a frequency of ambient noise and generate a reverse frequency of the frequency of the ambient noise for mutual attenuation or cancellation, thereby suppressing noise. The terminal detects that the noise reduction headset is inserted into the foregoing headset jack having the extended function, and receives a communication setting instruction. The communication setting instruction may be an instruction that is generated when a user activates a headset setting function or starts an application program on the terminal, or may be a level signal that conforms to a preset trigger state and that is generated when the user exerts a short press or a long press on a corresponding button on the noise reduction headset. Before the terminal receives the communication setting instruction, audio is transmitted between the terminal and the noise reduction headset, and after receiving the communication setting instruction, the terminal triggers the noise reduction headset to enter a communication mode. Further, the terminal may enable a communication triggering function on the third line, and trigger, using this line, the noise reduction headset to enter the communication mode. That is, the first line is enabled as a sending channel, and the second line is enabled as a receiving channel. In this case, both the terminal and the noise reduction headset start a communication mode.

Step 102: Receive a headset setting request in the communication mode, where the headset setting request is used to request a firmware upgrade and/or noise reduction parameter setting for the noise reduction headset.

In the communication mode, the terminal may perform data transmission with the noise reduction headset based on the extended lines of the headset jack. In this way, after receiving the headset setting request that is input by the user using a human-machine interaction module of the terminal, the terminal may communicate with the noise reduction headset according to the headset setting request. The headset setting request may be that the user requests firmware of the noise reduction headset to be upgraded, or may be that the user directly inputs an audio range intended to be reduced, a noise reduction level for a noise reduction environment, or the like. These may all be used as a basis for noise reduction headset upgrade or noise reduction range adjustment. It should be noted that, for the headset setting request, in addition to the foregoing several types of content, all information that may be used to indicate a noise reduction audio range of the noise reduction headset may be used as the headset setting request in this embodiment. This is not limited herein.

Step 103: Set the noise reduction headset according to the headset setting request using the preset headset jack.

The terminal device sets the noise reduction headset using the extended lines of the headset jack, including sending firmware for update to the noise reduction headset so that the noise reduction headset locally installs the firmware for update to implement an upgrade, transmitting a noise reduction parameter to the noise reduction headset so that the noise reduction headset flexibly adjusts a noise reduction range according to the noise reduction parameter.

In this embodiment, by extending lines of a headset jack of a terminal and a plug of a noise reduction headset, data communication between the terminal and the noise reduction headset is implemented, a problem that internal firmware, an audio parameter for noise reduction, and the like of a noise reduction headset are all fixed and unchangeable when the noise reduction headset leaves the factory is resolved, a noise reduction range of the noise reduction headset is flexibly adjusted, and practicability of the noise reduction headset is improved.

Further, a specific implementation method for triggering, when it is detected that a noise reduction headset is inserted into a preset headset jack and a communication setting instruction is received, the noise reduction headset to enter a communication mode in step 101 in the foregoing method embodiment may include outputting, according to the communication setting instruction using the third line, a level signal conforming to a preset trigger state, and triggering, after the level signal is output for a preset trigger time, the noise reduction headset to enter the communication mode when it is detected that the noise reduction headset is inserted into the preset headset jack and the communication setting instruction is received.

Further, when enabled for the communication triggering function, the third line may be a level input circuit. When detecting that the noise reduction headset is inserted into the headset jack, the terminal automatically suspends all applications occupying the left and right audio channels of the headset jack, and then continuously inputs a high level on the third line. After the high level is input for the preset trigger time, the first lines and the second lines in the headset jack and the plug of the noise reduction headset are all switched to a data transmission channel, and the terminal and the noise reduction headset are both ready for data transmission and enter the communication mode. The preset trigger time in this embodiment may be, for example, 2 seconds (s). That is, after continuously inputting a high level on the third line for 2 s, the terminal may trigger the noise reduction headset to enter the communication mode. A specific value of the preset trigger time is not limited.

Further, when the headset setting request includes a firmware upgrade request, a specific implementation method for setting the noise reduction headset according to the headset setting request using the preset headset jack in step 103 in the foregoing method embodiment may include obtaining a model of the noise reduction headset and a current firmware version of the noise reduction headset according to the firmware upgrade request, and downloading the firmware for update, and sending the firmware for update to the noise reduction headset using the sending channel if it is found, through searching according to the model of the noise reduction headset and the current firmware version of the noise reduction headset, that there is firmware for update corresponding to the model of the noise reduction headset.

The user inputs, using a touch-sensitive surface of the terminal, the request for upgrading the noise reduction headset, and the terminal reads the current model and a number of the used firmware version of the noise reduction headset according to the request, and then the terminal may automatically query online whether there is firmware for update corresponding to the model of the noise reduction headset. Herein, the terminal may obtain, by accessing a server, a website, or the like of a provider of the noise reduction headset, the firmware for update. If there is firmware for update, the terminal may prompt, using a display screen, the user to download online the firmware for update, and transmit the firmware for update to the noise reduction headset using the sending channel after downloading the firmware for update.

Further, when the headset setting request includes noise reduction parameter information, a specific implementation method for setting the noise reduction headset according to the headset setting request using the preset headset jack in step 103 in the foregoing method embodiment may include sending a noise reduction level in the noise reduction parameter information to the noise reduction headset using the sending channel such that the noise reduction headset filters noise according to the noise reduction level.

Further, the user inputs the noise reduction parameter information using the touch-sensitive surface of the terminal. The noise reduction parameter information may include the noise reduction level, an audio range needing to be filtered out, and the like. For example, eight levels in total: 0 to 7 are provided in a setting menu. The eight levels respectively correspond to causing the noise reduction headset to filter out sounds lower than 0 decibel (db), 15 db, 20 db, 25 db, 30 db, 35 db, 40 db, 45 db, and 50 db. After the user selects a noise reduction level, the terminal may directly send a noise reduction range corresponding to the level to the noise reduction headset, or may directly send the level to the noise reduction headset, and the noise reduction headset filters out audio of a corresponding frequency according to the level.

Further, when the headset setting request includes an application scenario, and the application scenario may include, for example, at home, on a road, or on a bus, a specific implementation method for setting the noise reduction headset according to the headset setting request using the preset headset jack in step 103 in the foregoing method embodiment may include sending a preset noise reduction level corresponding to the application scenario to the noise reduction headset using the sending channel such that the noise reduction headset filters noise according to the preset noise reduction level.

Further, the user inputs a current environment using the touch-sensitive surface of the terminal. For different environments, different noise reduction ranges, levels, or the like may be set for the noise reduction headset. For example, it is relatively quiet at home, and sounds from family around need to be heard, and the user sets the application scenario to home, and the terminal adjusts a noise reduction level corresponding to the scenario to 0, which is equivalent to turning off a noise reduction effect such that the user does not neglect ambient sounds while enjoying a music effect. When the user is walking on a road, low frequency noise needs to be filtered out, but for safety, sounds from horns of vehicles around cannot be neglected, and the user sets the application scenario to outdoor, and the terminal adjusts a noise reduction level corresponding to the scenario to 4 to filter out ambient sounds lower than 30 db such that the user keeps safety in mind while enjoying a quiet environment. When the user is on a bus, an environment is quite noisy, and the user sets the application scenario to public place, and the terminal adjusts a noise reduction level corresponding to the scenario to 7 to filter out ambient sounds lower than 50 db such that substantially all noise is completely filtered out. Further, when the headset setting request includes noise reduction parameter information, a specific implementation method for setting the noise reduction headset according to the headset setting request using the preset headset jack in step 103 in the foregoing method embodiment may include sending an audio intensity curve in the noise reduction parameter information to the noise reduction headset using the sending channel such that the noise reduction headset adjusts audio intensity of a corresponding sound frequency band according to the audio intensity curve.

Further, the user manually adjusts the audio curve using the touch-sensitive surface of the terminal to adjust audio intensity of sound frequency bands of the headset, and the terminal sends the audio curve to the noise reduction headset such that the noise reduction headset adjusts audio intensity of corresponding sound frequency bands according to the audio intensity curve.

Further, after step 103 in the foregoing method embodiment, the method further includes receiving a setting exiting request, and outputting, according to the setting exiting request using the third line, a level signal conforming to a preset exiting state to trigger the noise reduction headset to enter a voice mode, where in the voice mode, the first line is used for the first channel, the second line is used for the second channel, and the third line is used for the microphone.

Corresponding to entering the communication mode, after receiving the setting exiting request, the terminal may continuously input a low level on the third line such that the first lines and the second lines in the headset jack and the plug of the noise reduction headset are switched back to the voice mode again, that is, the first lines are used for the first channel, the second lines are used for the second channel, and the third lines are used for the microphone, and the noise reduction headset performs noise filtering on ambient sounds according to previous setting.

Further, before step 101 in the foregoing method embodiment, the method further includes displaying an interface for setting the noise reduction headset to a user, and receiving, using the interface, the headset setting request input by the user.

In this embodiment, the user may activate, by tapping on an icon of an application, a function of setting the noise reduction headset, and the application includes the setting interface displayed to the user. Optionally, the function of setting the noise reduction headset may also be a function of the terminal, and the user sets the noise reduction headset by selecting setting content.

Further, after step 101 in the foregoing method embodiment, the method further includes obtaining a model of the noise reduction headset and a current firmware version of the noise reduction headset, and downloading the firmware for update, and sending the firmware for update to the noise reduction headset using the sending channel if it is found, through searching according to the model of the noise reduction headset and the current firmware version of the noise reduction headset, that there is firmware for update corresponding to the model of the noise reduction headset.

In a process in which the terminal sets the noise reduction headset, the terminal may also actively obtain the model and the current firmware version of the noise reduction headset from the noise reduction headset, and then when there is a new version for firmware, send the firmware for upgrade to the noise reduction headset. Herein, there is no need for the user to input a headset setting request for firmware upgrade, and the terminal may automatically perform detection for upgrade.

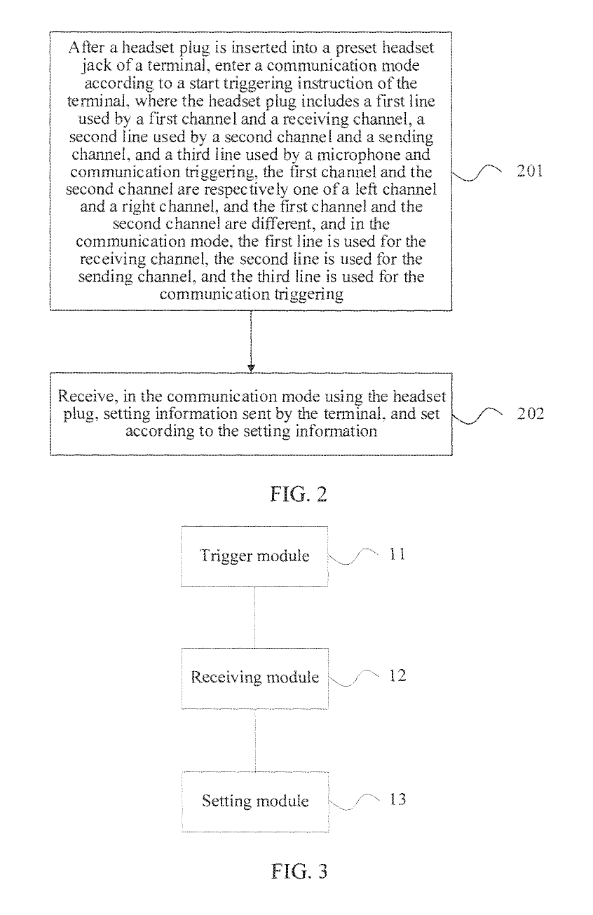

FIG. 2 is a flowchart of another embodiment of a noise reduction headset setting method according to the present disclosure. As shown in FIG. 2, the method in this embodiment may include the following steps.

Step 201: After a headset plug is inserted into a preset headset jack of a terminal, enter a communication mode according to a start triggering instruction of the terminal, where the headset plug includes a first line used by a first channel and a receiving channel, a second line used by a second channel and a sending channel, and a third line used by a microphone and communication triggering, the first channel and the second channel are respectively one of a left channel and a right channel, and the first channel and the second channel are different, and in the communication mode, the first line is used for the receiving channel, the second line is used for the sending channel, and the third line is used for the communication triggering.

This embodiment may be executed by the noise reduction headset in the embodiment shown in FIG. 1. The start triggering instruction may be an instruction that is generated when a user activates a headset setting function or starts an application program on the terminal, or may be a level signal that conforms to a preset trigger state and that is generated when the user exerts a short press or a long press on a corresponding button on the noise reduction headset.

Step 202: Receive, in the communication mode using the headset plug, setting information sent by the terminal, and set according to the setting information.

This embodiment corresponds to the method embodiment shown in FIG. 1, and explains method steps on a noise reduction headset side when a terminal sets a noise reduction headset, and details are not described herein again.

In this embodiment, by extending lines of a headset jack of a terminal and a plug of a noise reduction headset, data communication between the terminal and the noise reduction headset is implemented, a problem that internal firmware, an audio parameter for noise reduction, and the like of a noise reduction headset are all fixed and unchangeable when the noise reduction headset leaves the factory is resolved, a noise reduction range of the noise reduction headset is flexibly adjusted, and practicability of the noise reduction headset is improved.

Further, a specific implementation method for receiving, in the communication mode using the headset plug, setting information sent by the terminal, and setting according to the setting information in step 202 in the foregoing method embodiment may include sending, in the communication mode, a model of the noise reduction headset and a current firmware version of the noise reduction headset to the terminal using the sending channel, receiving, using the receiving channel, firmware for update sent by the terminal, and performing an upgrade according to the firmware for update.

Further, a specific implementation method for receiving, in the communication mode using the headset plug, setting information sent by the terminal, and setting according to the setting information in step 202 in the foregoing method embodiment may include receiving, in the communication mode using the receiving channel, a noise reduction level sent by the terminal, and filtering noise according to the noise reduction level.

Further, a specific implementation method for receiving, in the communication mode using the headset plug, setting information sent by the terminal, and setting according to the setting information in step 202 in the foregoing method embodiment may include receiving, in the communication mode using the receiving channel, an audio intensity curve sent by the terminal, and adjusting audio intensity of a corresponding sound frequency band according to the audio intensity curve.

Further, after step 202 in the foregoing method embodiment, the method further includes entering a voice mode according to an exit triggering instruction of the terminal, where in the voice mode, the first line is used for the first channel, the second line is used for the second channel, and the third line is used for the microphone.

The exit triggering instruction may be an instruction that is generated when the user deactivates the headset setting function or closes the application program on the terminal, or may be a level signal that conforms to a preset exiting state and that is generated when the user exerts a short press or a long press on a corresponding button on the noise reduction headset.

FIG. 3 is a schematic structural diagram of an embodiment of a terminal according to the present disclosure. As shown in FIG. 3, the apparatus in this embodiment may include a trigger module 11, a receiving module 12, and a setting module 13. The trigger module 11 is configured to trigger, when it is detected that a noise reduction headset is inserted into a preset headset jack and a communication setting instruction is received, the noise reduction headset to enter a communication mode. The preset headset jack includes a first line used by a first channel and a sending channel, a second line used by a second channel and a receiving channel, and a third line used by a microphone and communication triggering, the first channel and the second channel are respectively one of a left channel and a right channel, and the first channel and the second channel are different, and in the communication mode, the first line is used for the sending channel, the second line is used for the receiving channel, and the third line is used for the communication triggering. The receiving module 12 is configured to receive a headset setting request in the communication mode. The headset setting request is used to request a firmware upgrade and/or noise reduction parameter setting for the noise reduction headset. The setting module 13 is configured to set the noise reduction headset according to the headset setting request using the preset headset jack.

The apparatus in this embodiment may be configured to execute the technical solution of the method embodiment shown in FIG. 1, and implementation principles and technical effects thereof are similar, and details are not described herein again.

The trigger module 11 is further configured to output, according to the communication setting instruction using the third line, a level signal conforming to a preset trigger state, and trigger, after the level signal is output for a preset trigger time, the noise reduction headset to enter the communication mode when it is detected that the noise reduction headset is inserted into the preset headset jack and the communication setting instruction is received.

Further, the headset setting request includes a firmware upgrade request, and the setting module 13 is further configured to obtain a model of the noise reduction headset and a current firmware version of the noise reduction headset according to the firmware upgrade request, and download the firmware for update, and send the firmware for update to the noise reduction headset using the sending channel if it is found, through searching according to the model of the noise reduction headset and the current firmware version of the noise reduction headset, that there is firmware for update corresponding to the model of the noise reduction headset.

Further, the headset setting request includes noise reduction parameter information, and the setting module 13 is further configured to send a noise reduction level in the noise reduction parameter information to the noise reduction headset using the sending channel such that the noise reduction headset filters noise according to the noise reduction level.

Further, the headset setting request includes an application scenario, and the setting module 13 is further configured to send a preset noise reduction level corresponding to the application scenario to the noise reduction headset using the sending channel such that the noise reduction headset filters noise according to the preset noise reduction level.

Further, the headset setting request includes noise reduction parameter information, and the setting module 13 is further configured to send an audio intensity curve in the noise reduction parameter information to the noise reduction headset using the sending channel such that the noise reduction headset adjusts audio intensity of a corresponding sound frequency band according to the audio intensity curve.

The trigger module 11 is further configured to receive a setting exiting request, and output, according to the setting exiting request using the third line, a level signal conforming to a preset exiting state to trigger the noise reduction headset to enter a voice mode, where in the voice mode, the first line is used for the first channel, the second line is used for the second channel, and the third line is used for the microphone.

The setting module 13 is further configured to obtain a model of the noise reduction headset and a current firmware version of the noise reduction headset, and download the firmware for update, and send the firmware for update to the noise reduction headset using the sending channel if it is found, through searching according to the model of the noise reduction headset and the current firmware version of the noise reduction headset, that there is firmware for update corresponding to the model of the noise reduction headset.

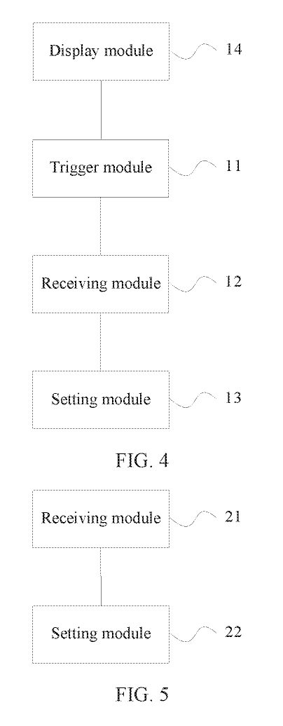

FIG. 4 is a schematic structural diagram of another embodiment of a terminal according to the present disclosure. As shown in FIG. 4, based on the apparatus structure shown in FIG. 3, the apparatus in this embodiment may further include a display module 14 configured to display an interface for setting the noise reduction headset to a user, and receive, using the interface, the headset setting request input by the user.

The apparatus in this embodiment may be configured to execute the technical solution of the method embodiment shown in FIG. 1, and implementation principles and technical effects thereof are similar, and details are not described herein again.

FIG. 5 is a schematic structural diagram of an embodiment of a noise reduction headset according to the present disclosure. As shown in FIG. 5, the apparatus in this embodiment may include a receiving module 21 and a setting module 22. The receiving module 21 is configured to enable, according to a start triggering instruction of a terminal, the noise reduction headset to enter a communication mode after a headset plug is inserted into a preset headset jack of the terminal. The headset plug includes a first line used by a first channel and a receiving channel, a second line used by a second channel and a sending channel, and a third line used by a microphone and communication triggering, the first channel and the second channel are respectively one of a left channel and a right channel, and the first channel and the second channel are different, and in the communication mode, the first line is used for the receiving channel, the second line is used for the sending channel, and the third line is used for the communication triggering. The setting module 22 is configured to receive, in the communication mode using the headset plug, setting information sent by the terminal, and set according to the setting information.

The apparatus in this embodiment may be configured to execute the technical solution of the method embodiment shown in FIG. 2, and implementation principles and technical effects thereof are similar, and details are not described herein again.

The setting module 22 is further configured to send, in the communication mode, a model of the noise reduction headset and a current firmware version of the noise reduction headset to the terminal using the sending channel, and receive, using the receiving channel, firmware for update sent by the terminal, and perform an upgrade according to the firmware for update.

The setting module 22 is further configured to receive, in the communication mode using the receiving channel, a noise reduction level sent by the terminal, and filter noise according to the noise reduction level.

The setting module 22 is further configured to receive, in the communication mode using the receiving channel, an audio intensity curve sent by the terminal, and adjust audio intensity of a corresponding sound frequency band according to the audio intensity curve.

The receiving module 21 is further configured to receive an exit triggering instruction of the terminal, and enable, according to the exit triggering instruction, the noise reduction headset to enter a voice mode, where in the voice mode, the first line is used for the left channel, the second line is used for the right channel, and the third line is used for the microphone.

FIG. 6 is a schematic diagram of connection between a terminal and a noise reduction headset according to the present disclosure. As shown in FIG. 6, the terminal in this embodiment includes a processor, a preset headset jack, a display, and a memory. The display includes a touch-sensitive surface (not shown) and a display screen (not shown). The memory is configured to store one or more application programs. The preset headset jack includes a first line used by a first channel and a sending channel, a second line used by a second channel and a receiving channel, and a third line used by a microphone and communication triggering, the first channel and the second channel are respectively one of a left channel and a right channel, and the first channel and the second channel are different, and when the preset headset jack is in a communication mode, the first line is used for the sending channel, the second line is used for the receiving channel, and the third line is used for the communication triggering. The processor may execute the technical solution of the method embodiment shown in FIG. 1, and implementation principles and technical effects thereof are similar, and details are not described herein again. The preset headset jack further includes a power line and a ground line. The one or more application programs include an application program for setting a noise reduction headset, and the display is configured to display an interface of the application program for setting a noise reduction headset to a user.

The noise reduction headset includes a headset plug and a noise reduction chip. The headset plug includes a first line used by a first channel and a receiving channel, a second line used by a second channel and a sending channel, and a third line used by a microphone and communication triggering, the first channel and the second channel are respectively one of a left channel and a right channel, and the first channel and the second channel are different, and when the noise reduction headset is in a communication mode, the first line is used for the receiving channel, the second line is used for the sending channel, and the third line is used for the communication triggering. The noise reduction chip may execute the technical solution of the method embodiment shown in FIG. 2, and implementation principles and technical effects thereof are similar, and details are not described herein again. The headset plug also includes a power line and a ground line.

The foregoing memory may be a computer readable storage medium storing one or more application programs. The one or more application programs include an instruction, and when executed by a terminal including a display and multiple application programs, the instruction causes the terminal to execute the technical solution in the method embodiment shown in FIG. 1, and details are not described herein again.

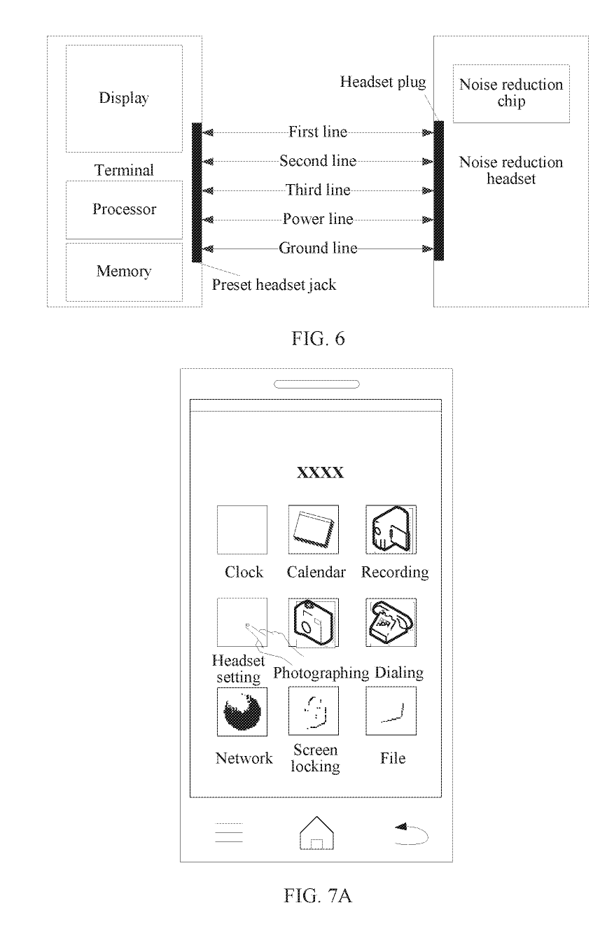

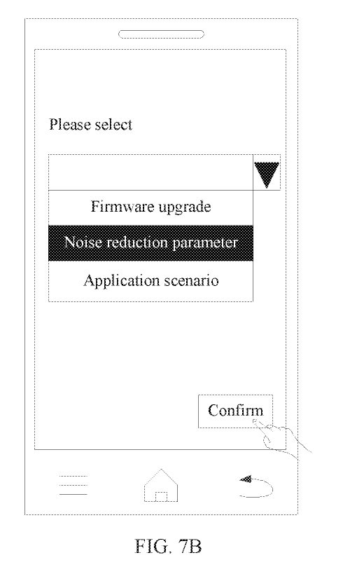

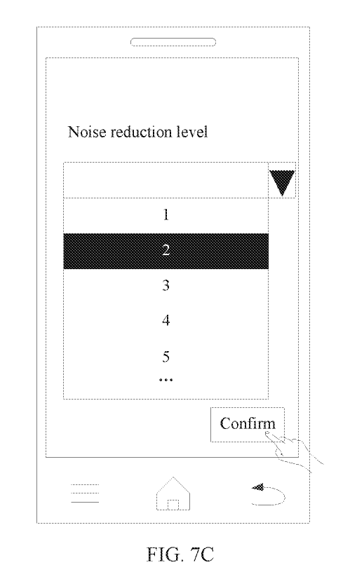

As an example, a noise reduction headset is set on a mobile phone. FIG. 7A to FIG. 7C are schematic diagrams of interfaces of a mobile phone according to the present disclosure. In FIG. 7A, a user taps on an icon of an application program for setting a noise reduction headset on the mobile phone. After the application program is started, as shown in FIG. 7B, a setting option menu is displayed on a display of the mobile phone. The setting option menu includes firmware upgrade, noise reduction parameter, and application scenario, and is used by the user to tap on one of the options, for example, the noise reduction parameter. In FIG. 7C, the user may select one from a level menu on the display. Optionally, an audio intensity curve may be directly input.

In the several embodiments provided in the present disclosure, it should be understood that the disclosed apparatus and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device) or a processor to perform a part of the steps of the methods described in the embodiments of the present disclosure. The foregoing storage medium includes any medium that can store program code, such as a universal serial bus (USB) flash drive, a removable hard disk, a read-only memory (ROM), a random access memory (RAM), a magnetic disk, or an optical disc.

It may be clearly understood by a person skilled in the art that, for the purpose of convenient and brief description, division of the foregoing function modules is taken as an example for illustration. In actual application, the foregoing functions can be allocated to different function modules and implemented according to a requirement, that is, an inner structure of an apparatus is divided into different function modules to implement all or part of the functions described above. For a detailed working process of the foregoing apparatus, reference may be made to a corresponding process in the foregoing method embodiments, and details are not described herein again.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

1.-33. (canceled)

34. A noise reduction headset setting method, comprising:
triggering a noise reduction headset to enter a communication mode when the noise reduction headset is inserted into a preset headset jack and a communication setting instruction is received, wherein the preset headset jack comprises a first line used by a first channel and a sending channel, a second line used by a second channel and a receiving channel, and a third line used by a microphone and communication triggering, wherein the first channel and the second channel are respectively one of a left channel and a right channel, wherein the first channel and the second channel are different, and wherein in the communication mode, the first line is used for the sending channel, the second line is used for the receiving channel, and the third line is used for the communication triggering;
receiving a headset setting request in the communication mode, wherein the headset setting request requests a firmware upgrade or noise reduction parameter setting for the noise reduction headset; and
setting the noise reduction headset according to the headset setting request using the preset headset jack.

35. The method according to claim 34, wherein triggering the noise reduction headset to enter the communication mode comprises:
outputting, according to the communication setting instruction using the third line, a level signal conforming to a preset trigger state; and
triggering the noise reduction headset to enter the communication mode after the level signal is output for a preset trigger time.

36. The method according to claim 34, wherein the headset setting request comprises a firmware upgrade request, and wherein setting the noise reduction headset comprises:
obtaining a model of the noise reduction headset and a current firmware version of the noise reduction headset according to the firmware upgrade request;
downloading firmware for update when it is found, through searching according to the model of the noise reduction headset and the current firmware version of the noise reduction headset, that there is the firmware for update corresponding to the model of the noise reduction headset; and
sending the firmware for update to the noise reduction headset using the sending channel.

37. The method according to claim 34, wherein the headset setting request comprises noise reduction parameter information, and wherein setting the noise reduction headset comprises sending a noise reduction level in the noise reduction parameter information to the noise reduction headset using the sending channel such that the noise reduction headset filters noise according to the noise reduction level.

38. The method according to claim 34, wherein the headset setting request comprises an application scenario, and wherein setting the noise reduction headset comprises sending a preset noise reduction level corresponding to the application scenario to the noise reduction headset using the sending channel such that the noise reduction headset filters noise according to the preset noise reduction level.

39. The method according to claim 34, wherein the headset setting request comprises noise reduction parameter information, and wherein setting the noise reduction headset comprises sending an audio intensity curve in the noise reduction parameter information to the noise reduction headset using the sending channel such that the noise reduction headset adjusts audio intensity of a corresponding sound frequency band according to the audio intensity curve.

40. The method according to claim 34, wherein after setting the noise reduction headset, the method further comprises:
receiving a setting exiting request; and
outputting, according to the setting exiting request using the third line, a level signal conforming to a preset exiting state to trigger the noise reduction headset to enter a voice mode, and
wherein in the voice mode, the first line is used for the first channel, the second line is used for the second channel, and the third line is used for the microphone.

41. The method according to claim 34, wherein before triggering the noise reduction headset to enter the communication mode, the method further comprises:
displaying an interface for setting the noise reduction headset to a user; and
receiving, using the interface, the headset setting request input by the user.

42. The method according to claim 34, wherein after triggering the noise reduction headset to enter the communication mode, the method further comprises:
obtaining a model of the noise reduction headset and a current firmware version of the noise reduction headset;
downloading firmware for update when it is found, through searching according to the model of the noise reduction headset and the current firmware version of the noise reduction headset, that there is the firmware for update corresponding to the model of the noise reduction headset; and
sending the firmware for update to the noise reduction headset using the sending channel.

43. A noise reduction headset setting method, comprising:
entering a communication mode according to a start triggering instruction of a terminal after a headset plug is inserted into a preset headset jack of the terminal, wherein the headset plug comprises a first line used by a first channel and a receiving channel, a second line used by a second channel and a sending channel, and a third line used by a microphone and communication triggering, wherein the first channel and the second channel are respectively one of a left channel and a right channel, wherein the first channel and the second channel are different, and wherein in the communication mode, the first line is used for the receiving channel, the second line is used for the sending channel, and the third line is used for the communication triggering;
receiving, in the communication mode using the headset plug, setting information from the terminal; and
setting according to the setting information.

44. The method according to claim 43, wherein receiving the setting information, and setting according to the setting information comprises:
sending, in the communication mode, a model of a noise reduction headset and a current firmware version of the noise reduction headset to the terminal using the sending channel;
receiving, using the receiving channel, firmware for update from the terminal; and
performing an upgrade according to the firmware for update.

45. The method according to claim 43, wherein receiving the setting information, and setting according to the setting information comprises:
receiving, in the communication mode using the receiving channel, a noise reduction level from the terminal; and
filtering noise according to the noise reduction level.

46. The method according to claim 43, wherein receiving the setting information, and setting according to the setting information comprises:
receiving, in the communication mode using the receiving channel, an audio intensity curve from the terminal; and
adjusting audio intensity of a corresponding sound frequency band according to the audio intensity curve.

47. The method according to claim 43, wherein after receiving the setting information, and setting according to the setting information, the method further comprises entering a voice mode according to an exit triggering instruction of the terminal, and wherein in the voice mode, the first line is used for the first channel, the second line is used for the second channel, and the third line is used for the microphone.

48. A terminal, comprising
a processor;
a preset headset jack coupled to the processor;
a display coupled to the processor; and
a memory coupled to the processor,
wherein the display comprises a touch-sensitive surface and a display screen,
wherein the memory is configured to store one or more application programs,
wherein the preset headset jack comprises:
a first line used by a first channel and a sending channel;
a second line used by a second channel and a receiving channel; and
a third line used by a microphone and communication triggering,
wherein the first channel and the second channel are respectively one of a left channel and a right channel,
wherein the first channel and the second channel are different,
wherein the first line is used for the sending channel, the second line is used for the receiving channel, and the third line is used for the communication triggering when the preset headset jack is in a communication mode, and
wherein the processor is configured to:
receive a headset setting request in the communication mode, wherein the headset setting request requests a firmware upgrade or noise reduction parameter setting for a noise reduction headset; and
set the noise reduction headset according to the headset setting request using the preset headset jack.
